(19) United States
(12) Patent Application Publication
(10) Pub. No.: US 2015/0089287 A1
(43) Pub. Date: Mar. 26, 2015

(54) EVENT-TRIGGERED STORAGE OF DATA TO NON-VOLATILE MEMORY

(71) Applicants: Sarathy Jayakumar, Portland, OR (US); Mohan J. Kumar, Aloha, OR (US); Krishnakanth V. Sistla, Beaverton, OR (US)

(72) Inventors: Sarathy Jayakumar, Portland, OR (US); Mohan J. Kumar, Aloha, OR (US); Krishnakanth V. Sistla, Beaverton, OR (US)

(21) Appl. No.: 14/127,548

(22) PCT Filed: Sep. 23, 2013
(86) PCT No.: PCT/US2013/061188

§ 371 Date: Dec. 19, 2013

(51) Int. Cl. G06F 11/07; G06F 13/24; G06F 11/30; G06F 12/08; G06F 11/16; G06F 1/30

(52) U.S. Cl. CPC G06F 11/079; G06F 11/165; G06F 1/30; G06F 11/3072; G06F 12/0802; G06F 13/24
USPC 714/23; 711/118; 714/39; 714/48

(57) ABSTRACT

An event management resource monitors a processor environment. In response to detecting occurrence of a trigger event in the processor environment, the event management resource initiates a transfer of processor cache data from volatile storage in the processor environment to non-volatile memory. The event management resource can be configured to produce status information associated with the transfer of cache data to a respective non-volatile memory resource. The event management resource stores the status information in a non-volatile storage resource for later retrieval. Accordingly, status information associated with the event causing the transfer is available for analysis on subsequent power up or reboot of a respective computer system.

### BACKGROUND

Many modern computerized devices require the ability to store data persistently in a non-volatile memory even when power to the device is turned off. An example of memory that is able to accomplish this is a Non-Volatile Dual In-line Memory Module (NVDIMM). A typical NVDIMM includes a non-volatile storage medium such as NAND or NOR flash memory for storing digital information in an array of memory cells. Because the digital information (i.e. data) is stored in non-volatile NAND/NOR flash memory, the data is “durable” and persists in the computer system/computerized device during power loss or system failures. After power is restored to computerized device utilizing the NVDIMM, the corresponding computerized device can access the stored digital data front the NVDIMM.

In certain instances, in accordance with received input, software in a respective computer device an modify data Stored in non-volatile memory. For example, assume that software desires to update a record (such as record A) stored in non-volatile memory. In such an instance, the software retrieves a copy of the original record A stored in non-volatile memory and stores a copy of the record A in corresponding volatile memory.

While in volatile memory, the software makes appropriate changes or updates to the copy (i.e., record A′) of the record. Subsequent to completing any changes to record A′ (copy) in the volatile memory, the software then initiates storage of the updated copy of the record A′ to non-volatile memory. As discussed above, if storage of record A′ is successfully copied to the nota-volatile memory prior to depowering, the modified record A′ is retrievable from the non-volatile memory.

If a failure such as loss of power occurs prior to complete storage of modified record A′ to target non-volatile memory, it is possible that none or only a portion of the record A′ (as opposed to all of record A′) gets written to non-volatile memory.

In certain instances, as a result of the failure, corresponding status information associated with record A′ can incorrectly indicate that the partially written for potentially corrupted) copy of record A′ in non-volatile memory is the latest copy for record A. In such an instance, the power failure results in loss of data because the modified record A′ is not properly stored in non-volatile memory.

### BRIEF DESCRIPTION OF THE DRAWINGS

The accompanying drawings which are incorporated in and constitute a part of this specification, illustrate one or more embodiments described herein and, together with the Detailed Description, explain these embodiments. In the drawings:

FIG. 1 is a block diagram of an example processor environment according to embodiments herein;

FIG. 2 is an example diagram illustrating monitoring of different types of events decoding to embodiments herein;

FIG. 3 is an example diagram illustrating implementation of an SMI (System Management Interrupt) handler configured to manage detected trigger events according to embodiments herein;

FIG. 4 is a block diagram of an example computer system operative to implement methods according to embodiments herein;

FIG. 5 is a flow diagram illustrating an example method of managing detected trigger events according to embodiments herein; and

FIG. 6 is an example diagram illustrating a computer system and corresponding display screen according to embodiments herein.

### DETAILED DESCRIPTION

In general, loss of data (due to an event such as loss of power, hardware failure, software reset, etc.) is highly undesirable because it prevents recovery of a respective computer system back to its original state prior to occurrence of the event. For example, as discussed above, modified data in a record may not be properly stored in respective non-volatile memory prior to complete power shut down of the respective computer system.

Certain embodiments as discussed herein include an event management resource providing more advanced ways of saving data compared to conventional techniques. For example, the event management resource monitors a processor environment. In contrast to conventional techniques, and in response to detecting occurrence of a trigger event in the processor environment, the event management resource initiates a transfer of processor cache data from volatile storage (such as one or more corresponding caches) in the processor environment to on-volatile memory.

In one embodiment, the event management resource can be configured to produce status information associated with the transfer of cache data to a respective non-volatile memory resource. The event management resource stores the status information in a non-volatile storage resource for later retrieval. Accordingly, status information associated with the event causing the transfer can be made available for analysis on subsequent power up or reboot of a respective computer system.

By further way of a non-limiting example, the event, management resource can be configured to produce first status information indicating the occurrence of the underlying trigger event causing the transfer of cache data to non-volatile memory. The event management resource can be configured to store the first status information in a non-volatile storage resource such that the status information is available at a later point in time after removal and subsequent reapplication of power.

In accordance with yet further embodiments, the event management resource can be configured to produce second status information to indicate whether an initiated transfer of the processor cache data to the non-volatile memory was successful or not. The event management resource also can be configured to store the second status information in a respective non-volatile storage resource such that the status information is available at a later point in time after removal and reapplication of power.

Accordingly, on a subsequent power up and/or reboot of the processor environment, the first status information and second status information are available for retrieval and analysis to determine whether cache data during a previous session of using the computer was stored in non-volatile memory prior to a reset event.

In one embodiment, the computer system can be configured to execute BIOS (Basic Input Output System) software upon reboot of the computer system. The software can be configured to make an inquiry as to settings of the stored status information to determine if the last power down of a respective computer system was caused by a corresponding undesirable event such as a power failure. Further, based on settings of the status information, the software can determine whether corresponding data (such as cache data stored in volatile storage) was properly stored to non-volatile memory prior to complete loss of power.

In yet further embodiments, on a subsequent reboot, the software (or other suitable resource) can be configured to reset the first status information and the second information on a respective software reboot. Clearing of the status information ensures that each time the status information is read from storage during initial power up indicates whether corresponding cache data for a previous session of using the respective computer device was stored in non-volatile memory.

By further way of a non-limiting example, a fault manager resource can be configured to retrieve the status information and store such information in a respective log. Accordingly, the respective log can be used to detect a history of fault conditions, reset conditions. etc.

In certain instances, the cache data saved to non-volatile memory can be used to restore the processor environment to a state prior to occurrence of a respective failure. Accordingly, embodiments herein include mitigating loss of data during trigger events such as loss of power.

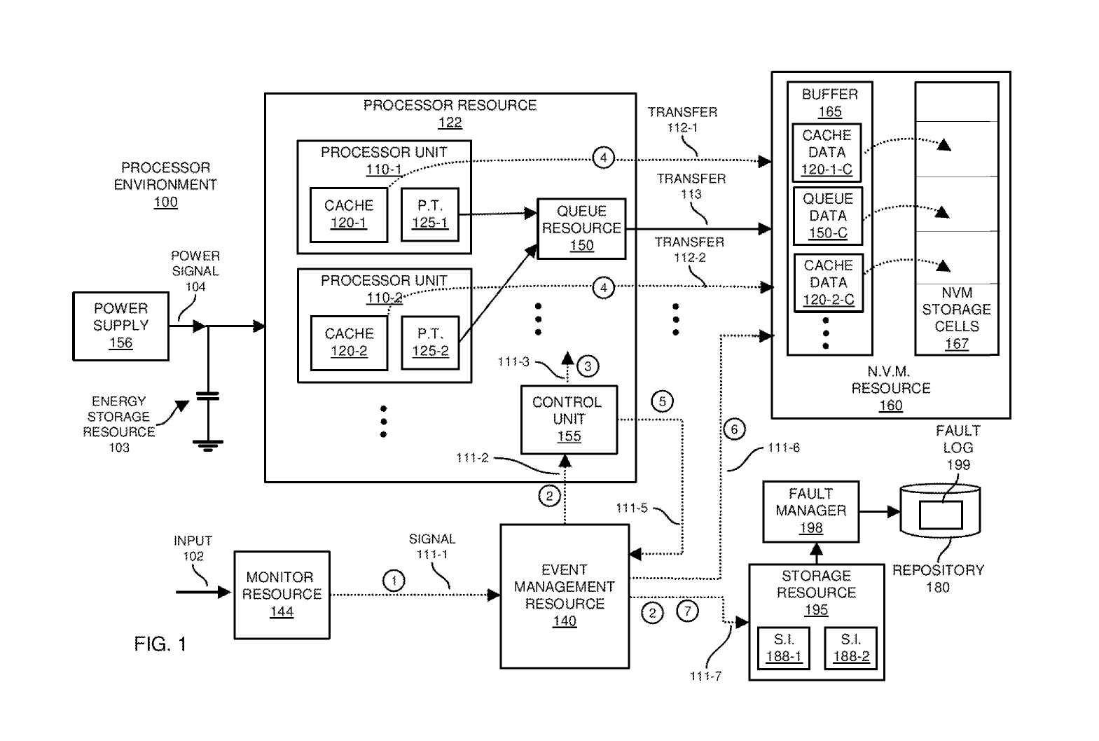

Now, more specifically, FIG. 1 is an example diagram illustrating a processor environment according to embodiments herein.

As shown, processor environment 100 can include processor resource 122, corresponding power supply 156, monitor resource 144, event, management resource 140, non-volatile memory resource 160, storage resource 195, fault manager 198, and repository 180.

As shown, power supply 156 produces power signal 104 to power processor resource 122. Power signal 104 can be configured to generate any suitable voltage to power one or more different types of devices in processor environment 100.

In this non-limiting example embodiment, energy storage resource 103 such as one or more capacitors stores at least a portion of power provided by power supply 156. In the event of a power failure (such as a condition in which the power supply 156 no longer outputs power signal 104 in a proper voltage range to power processor environment 122), the energy stored in energy storage resource 103 continues to provide appropriate power to processor resource 122 for at least a limited amount of holdup time.

An amount of holdup time can vary depending on parameters such as an amount of power consumed by processor resource 122, an energy storage capacity associated with energy storage resource 103, etc. By way of a non-limiting example, the energy storage resource can be configured to hold up the processor resource 122 on the order of milliseconds or any other suitable amount.

As further shown, processor resource 122 can be configured to include one or more processor units 110 such as processor unit 110-1, processor unit 110-2, etc.

In one embodiment, processor units 110 execute corresponding software instructions to perform the same or different functions. Software instructions executed by processor units 110 can be retrieved from any suitable resource such as storage cells 167 of non-volatile memory resource 160.

In this example embodiment, each of the processor units 110 includes a corresponding cache resource facilitating execution of a respective processing thread. Caches 120 (cache 120-1, cache 120-2, . . . ) can be configured to store any suitable type of information such as executable code, retrieved, data, modified data, etc., used by a respective processor unit

Typically, the caches 120 store data (on behalf of a respective processor unit) so that future requests (by the respective processor unit) for that data can be served faster. For example, the data stored in a respective cache can include data values such as previously computed values that are also stored elsewhere. If requested data is contained in the cache (i.e., there is a cache hit), the respective request can be served by simply reading the cache. Reading from or writing to a corresponding cache is comparatively faster than accessing another memory resource such as non-volatile memory resource 160, DRAM, etc.) that stores respective data.

Each of caches 120 can be volatile storage resource. That is, removal of power to the caches 120 results in loss of data. Recall that energy storage resource 103 provides some holdup time even after power signal 104 is terminated.

In this example embodiment, processing thread 125-1 utilizes cache 120-1 to store data and execute respective software functionality; processing thread 125-2 utilizes cache 120-2 to store data and execute respective software functionality; and so on.

During execution of software in respective processor units 110, the respective processing threads 125 can commit certain data for storage in non-volatile memory resource 160. For example, processor resource 122 can include queue resource 150 such as one or more so-called called write pending queues to store data that is to be stored in non-volatile memory resource 160. Via transfer 113, the queue resource 150 copies of corresponding, data stored in queue resource 150 to buffer 165 as queue data 150-C.

Eventual storage of respective queue data in buffer 165 (such as a volatile memory resource) to non-volatile memory storage cells 167 ensures that corresponding data in queue resource 150 will be available after processor resource 122 is shut down and re-powered again at a later time. The transfer 113 of data in queue resource 150 occurs during normal during operating conditions, absent a failure.

As previously discussed, processor environment 100 includes monitor resource 144 to monitor input 102. As its name suggests, monitor resource 144 monitors input 102 to detect occurrence of events in processor environment 100.

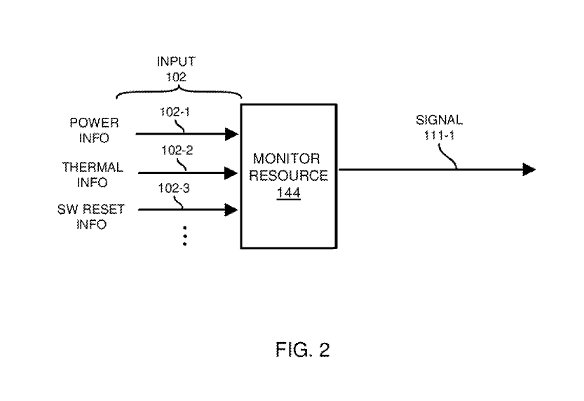

FIG. 2 is an example diagram illustrating different types of information potentially monitored by monitor resource according to embodiments herein.

As shown, input 102 can include: i) power information 102-1 such as a status of power signal 104 used to power processor resource 122, ii) thermal information 102-2 such as information received from a thermal device detecting a temperature of processors units 110 in processor environment 122, iii) software reset information 102-3 indicating whether executed software initiates a reset or reboot condition, etc.

By way of a non-limiting example, events can include: failure of power supply 156 to produce power signal 104 (causing the respective computer system to shut down), a software initiated reset condition in which software initiates a reboot of the processor resource 122, thermal overload events, etc.

Referring again to FIG. 1, assume in this example that input 102 indicates occurrence of a trigger event such as loss of power signal 156. In such an instance, monitor resource 144 detects the occurrence of the loss of power condition and generates signal 111-1 to event management resource 140. Energy storage resource 103 provides power to processor resource 122 for at least a short duration of time after power signal 104 is terminated.

Via signal 111-1, the event management resource 144 notifies event management resource 140 of the respective trigger event such as loss of power.

Note that event management resource 140 can be any suitable type of resource. For example, all or a portion of event management resource 140 can be a hardware resource disparately located with respect to the processor resource 122; all or a portion of event management resource 140 can be a hardware resource integrated into processor resource 122; all or a portion of event management resource 140 can be functionality executed by one or more processing threads 125; and so on.

Recall that energy storage resource 103 stores some amount of energy to hold up (i.e., continue to power) processor resource 122 after the power signal 104 is terminated. As mentioned, the amount of holdup time provided by energy storage resource 103 may vary. Embodiments herein include initiating a transfer of cache data stored in caches 120 to respective non-volatile memory within a respective window of time afforded by the hold-up time associated with energy storage resource 103.

Upon detection of a trigger event (such as loss of power signal 104) as specified by the signal 111-1, the event management resource 140 performs one or more functions. For example, in response to detecting a respective trigger event, the event management resource 140 initiates storage of status information 188-1 in storage resource 195. Status information 188-1 indicates occurrence of the detected event.

Note that storage resource 195 can be any suitable type of non-volatile resource such as registers, non-volatile memory cells, battery backed up volatile memory cells, etc., that retains respective state information after re-power or reboot of the processor environment 100. Storage resource 195 can be integrated within event management resource 140 or disparately located with respect to the event management resource 140.

In response to detecting a respective trigger event as indicated by signal 111-1, the event management resource 140 generates signal 111-2, indicating occurrence of the trigger event to control unit 155.

In response to received signal 111-2 and corresponding notification of the respective trigger event, the control unit 155 generates control signals 111-3 to perform one or more of the following functions such as: i) block further execution of instructions by respective processor units 110; ii) block inbound traffic to and outbound traffic from processor units 110 in processor resource 122: iii) initiate transfers 112 (e.g., transfer 112-1, transfer 112-2, etc.) of cache data to buffer 165; and iv) initiate a transfer of queue data in queue resource 150 to buffer 165 as queue data 150-C.

The transfer 112 of data in caches 120 to buffer 165 can include: copying cache data stored in cache 120-1 to buffer 165 as cache data 120-1-C; copying cache data stored in cache 120-2 to buffer 165 as cache data 120-2-C; and so on.

Cache data in respective caches 120 can be copied in parallel or sequentially into buffer 165.

Accordingly, the processor environment 100 can be configured to include multiple processor units 110 and corresponding caches 120. The transfers of cache data to non-volatile memory resource 160 can include initiating a transfer of processor cache data in each of the multiple corresponding caches 120 to the buffer 165 in non-volatile memory 160 in accordance with control signals 111-3 as generated by control unit 155. In one embodiment, the control unit 155 communicates the control signal 111-3 to one or more respective processor units 110 to initiate a transfer of cache data to the buffer 165.

Note that non-volatile memory resource 160 can be or include any suitable type of storage resources such as NAND flash devices, NOR flash devices, Magnetoresistive Random Access Memory (MRAM) devices, Ferroelectric Random Access Memory (FeTRAM) devices, 3-Dimensional (3-D) crosspoint memory devices such as Phase Change Memory (PCM), nanowire-based non-volatile memory, memory that incorporates memristor (memory resistor) technology, Spin Transfer Torque (STT)-MRAM, etc.

In one embodiment, the control unit 155 or other suitable resource or resources (such as processor units 110) selects a particular processor unit amongst the multiple processor units 110 to execute the transfers 112 of processor cache data in each of the multiple corresponding caches 120 to the non-volatile memory resource 160.

Alternatively, each of the corresponding processor units 110 can be notified by the control unit 155 to simultaneously transfer respective cache data to buffer 165.

After detecting occurrence of appropriate transfers 112 (as indicated by processor units 110) of the copies of cache data (and potentially other respective data such as queue data in queue resource 150) to buffer 165, the control unit 150 initiates depowering of the circuitry in processor resource 122. Subsequent to the appropriate transfers of cache data and queue data, the control unit 155 generates feedback signal 111-5 to event management resource 140. The signal 111-5 indicates whether the transfer of cache data to buffer 165 was successful or not.

Assume in this example that signal 111-5 indicates a successful transfer of cache data and queue data to buffer 165 in non-volatile memory resource 160.

In response to receiving feedback signal 111-5 from control unit 155 indicating that the initiated transfers 112 of processor cache data from volatile storage resources (such as from respective caches 120) in the processor environment 100 to buffer 165 in non-volatile memory resource 160 was successful, the event management resource 140 generates a command such as signal 111-6 to the non-volatile memory resource 160.

In one embodiment, the signal 111-6 indicates to transfer the processor cache data (and potentially other data such as queue data 150-C) from volatile buffer 165 in the non-volatile memory resource 160 to corresponding non-volatile storage cells 167 in the non-volatile memory resource 165.

By way of a non-limiting example, the signal 111-6 can be configured to drive one or more respective SAVE pins of the non-volatile memory resource 160 to commit respective data in buffer 165 to non-volatile storage cells 167.

Note that non-volatile memory resource 160 also can include a corresponding energy storage resource such as a capacitor bank. In such an instance, the capacitor bank in the non-volatile memory resource 160 enables final storage of data in buffer 165 to corresponding non-volatile memory storage cells 167 even though externally applied power to the non-volatile memory resource 160 has been terminated due to a condition such as a power failure.

In one embodiment, buffer 165 is volatile storage such as DRAM (Dynamic Random Access Memory). In response to receiving signal 111-6, the non-volatile memory resource 160 initiates a transfer of respective data in buffer 165 to respective non-volatile memory storage cells 167. As previously discussed, transfer of the data in buffer 165 to the non-volatile storage cells 167 ensures that the respective cache data, queue data, etc., is available after rebooting or re-powering the processor resource 122 again. Data stored in buffer 165 may be lost after complete power down of non-volatile memory resource 160.

Further note that in addition to generating signal 111-6, event management resource 140 generates signal 111-7 to store status information 188-2 in storage resource 195. In this example embodiment, status information 188-2 indicates the cache data transferred from respective caches 120 was properly stored to non-volatile memory storage cells 167.

If the event management resource 140 does not receive notification that the corresponding data was not properly transferred to the buffer 165 prior to depletion of energy in energy storage resource 103, the event management resource generates the status information 188-2 to indicate that the cache data transferred from respective caches 120 was not properly stored to non-volatile memory storage cells 167.

On a subsequent power up and/or reboot of the processor environment 100, the status information 188 (status information 188-1 and status information 188-2) is available for retrieval and analysis.

For example, the processor environment 100 pan be configured to execute fault manager 198 (such as BIOS software, BIOS initiated software, etc.) upon reboot of the processor environment 100. The fault manager 198 can be configured to make an inquiry as to settings of the stored status information 188-1 to determine if the last power down of processor environment 100 was caused by a corresponding undesirable event such as a power failure, thermal condition, etc.

If so, and based on settings of the status information 188-2, the fault manager 198 determines whether corresponding data (such as cache data stored in volatile storage) was properly stored to storage cells 167 of non-volatile memory resource 160 prior to complete loss of power. The feedback provided by status information 188 can trigger critical recovery of corresponding data such as retrieval or analysis cache data) in non-volatile memory resource 160 if the status information 188 indicates that a failure occurred and that corresponding cache data is stored in corresponding portions of non-volatile memory configured to store such data.

In one embodiment, on a subsequent reboot of processor resource 122, after making an inquiry to status information 188, initialization software or other suitable resource can be configured to reset the status information 188-1 and the status information 188-2. Clearing or resetting of the status information 188 at or around a time of reboot or re-powering ensures that the status information 188 stored in storage resource 195 corresponds to a last power state and corresponding use of the processor resource 122.

By further way of a non-limiting example, the fault manager 198 can be configured to retrieve the status information 488 and store such information in a respective fault log 199. Accordingly, the respective fault log 199 can be used to detect a history of one or more different types of fault conditions occurring in processor environment 100.

If the fault manager 198 detects occurrence of a trigger condition as indicated by status information 188, the fault manager 198 can utilize the stored cache data, queue data, etc., to restore the computer system back to its original state prior to the trigger event causing shut down of the processor units 110 in processor environment 100.

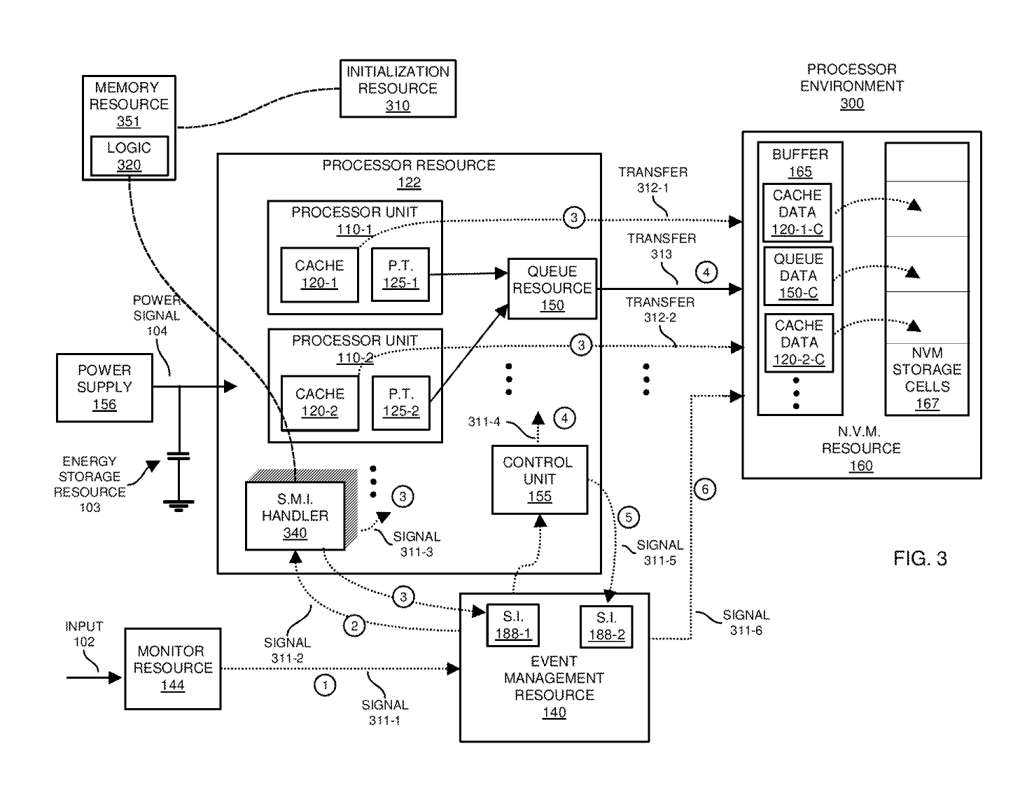

FIG. 3 is an example diagram illustrating execution of an interrupt handler and related functionality according to embodiments herein.

In this example, the processor environment 300 includes initialization resource 310. In one embodiment, one or more of the corresponding processor units 110 executes the initialization resource 310 (such as BIOS software, initialization software, BOOT software, etc.) upon boot, reboot, initial powering, etc., of respective processor environment 300.

Subsequent to application of initial power to processor environment 300, as its name suggests, the initialization resource 310 initiates retrieval of logic 320 (such as software instructions, code, etc.) from a suitable resource such as storage cells 167 of non-volatile memory resource 160 and stores the logic 320 in memory resource 351 (such as DRAM) for execution.

By way of a non-limiting example, as mentioned, logic 320 can represent software instructions associated with a respective operating system retrieved from non-volatile memory resource 160 during boot. As mentioned, processor units 110 can be configured to execute the logic 320.

Execution of logic 320 by one or more processor units 110 in processor environment 300 produces functionality associated with system management interrupt handler 340.

In this example, and in a similar manner as previously discussed, monitor resource 144 monitors the processor environment 300 for trigger events. Monitor resource 144 generates a respective notification signal 311-1 to event management resource 140 in response to detecting a corresponding trigger event such as loss of power, a software initiated processor reset, thermal overload condition, etc.

As previously discussed, trigger events can include: i) occurrence of a power failure associated with power supply 156 in which primary power signal 104 supplied to the processor resource 122 has been interrupted, ii) occurrence of a software initiated reset condition, iii) occurrence of a thermal overheating condition in the processor environment 300, etc.

In this example embodiment, in response to receiving the notification signal 311-1, the event management resource 140 generates a respective interrupt signal 311-2 to system management interrupt handler 340.

As its name suggests, system management interrupt handler 340 processes received interrupts.

In response to detecting occurrence of interrupt signal 311-2, system management interrupt handler 340 generates one or more control signals 311-3.

By way of a non-limiting example, via controls signals 311-3, the system management interrupt handler 340: i) blocks inbound and outbound traffic with respect to processor units 110 in processor environment 300, ii) communicates with one or more processor units 110 to initiate a transfer 312 (e.g., transfer 312-4, transfer 312-2, . . . ) of processor cache data from volatile storage (such as respective caches 120) to the buffer 165 in non-volatile memory resource 160, iii) sets one or more status bits of status information 188-1 to indicate that a respective trigger event occurred, iv) generates a command to notify the control unit 155 of the trigger event, and v) halts execution of respective processing threads 125.

In response to receiving notification of the trigger event from system management interrupt handler 340 (based on either from status information 188-1 or from a command from the system management interrupt handler 340 directly to the control unit 155), the control unit 155 generates respective one or more control signals 311-4.

In this example embodiment, the control signals 311-4 cause a transfer 313 of queue data stored in queue resource 150 to butler 165. In one embodiment as mentioned, queue resource 150 is a write pending queue used by the respective processor units 110 during normal operation to store data that is to be subsequently written to non-volatile memory resource 160.

In response to detecting completion of transfer 313 of queue data from queue resource 150 to buffer 165 and completion of transfers 312 initiated by system management interrupt 340, the control unit 155 generates signal 311-5 to update status information 188-2 to indicate that transfers such as transfers 312, 313, etc., were successful and/or have completed.

Subsequent to detecting completion of the transfers as indicated by the status information 188-2, the event management resource 140 generates a command such as signal 311-6 to the non-volatile memory resource 160. In one embodiment, the signal 311-6 indicates to transfer the copy of cache data 120-1-C, 120-2-C, . . . (and other data such as queue data 150-C) from respective volatile buffer 165 in the non-volatile memory resource 160 to respective non-volatile storage cells 167 in the non-volatile memory resource 165.

By further way of a non-limiting example, and in a manner as previously discussed, the signal 311-6 can be configured to drive a respective SAVE pin on the non-volatile memory resource 160 to commit respective data in buffer 165 to non-volatile storage cells 167. Also, as previously discussed, non-volatile memory resource 160 can include one or more corresponding energy storage resources such as a capacitor bank (such as multiple capacitors). As mentioned, such a capacitor bank enables final storage of data in buffer 165 to corresponding non-volatile memory storage cells 167 even though externally applied power to the non-volatile memory resource 160 has been terminated due to a condition such as a power failure.

Note that upon initial power up of processor environment 300, initialization resource 310 (and/or corresponding logic 320) can be configured to access previously stored status information 188-1 to determine whether a prior shut down of processor environment 300 was caused by a respective trigger event such as loss of power. Initialization resource 310 (and/or executed logic 320) can be configured to access status information 188-2 to determine if respective cache data was properly stored in non-volatile memory resource 160 prior to completion of last shutting down or depowering of processor environment 300.

Subsequent to accessing the status information 188 at initial power up, the initialization resource 310 (and/or corresponding logic 320) can be configured to clear or reset the status information 188-1 and 188-2 (indicating that no trigger event occurred). In a manner as previously discussed, if a respective trigger event occurs during a respective session of using the processor resource 122, the status information 188 is set again to reflect such a condition.

Recall that in one embodiment, status information 188-1 indicates whether the previous depowering of processor units 110 was caused by an undesirable condition such as loss of power, software crash, etc. Status information 188-2 indicates whether corresponding cache data in caches 120 was properly transferred to buffer 165 of non-volatile memory resource 160 prior to complete shut down of processor units 110.

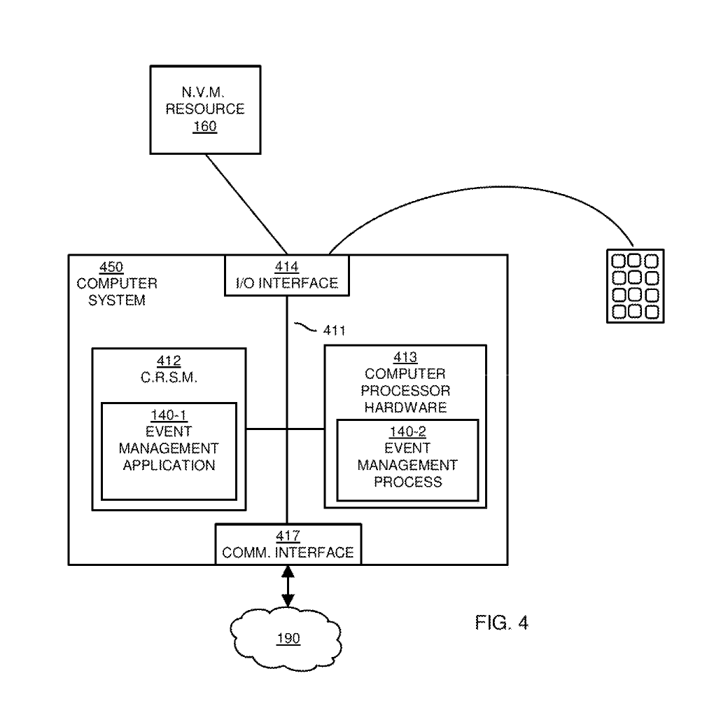

FIG. 4 is an example block diagram of a computer system for implementing any of the operations as discussed herein according to embodiments herein.

Computer system 450 can be configured to execute any of the operations with respect to event management resource 140, system management interrupt handler 340, etc.

As shown, computer system 450 of the present example can include an interconnect 411 that couples computer readable storage media 412 such as a physical non-transitory type of media (i.e., any type of physical hardware storage medium) in which digital information can be stored and retrieved, computer processor hardware 413 (i.e., one or more processor devices), I/O interface 414, communications interface 417, etc.

As shown, I/O interface 414 provides computer system 450 connectivity to data stored in non-volatile memory resource 160.

Computer readable storage medium 412 can be any physical or tangible hardware storage device or devices such as memory, optical storage, hard drive, floppy disk, etc. In one embodiment, the computer readable storage medium 412 (e.g., a computer readable hardware storage) stores instructions and/or data.

In one embodiment, communications interface 417 enables the computer system 450 and respective computer processor hardware 413 to communicate over a resource such as network 190 to retrieve information from remote sources and communicate with other computers. I/O interface 414 enables computer processor hardware 413 to retrieve stored information from non-volatile memory resource 160.

As shown, computer readable storage media 412 is encoded with event management application 140-1 (e.g., logic, software, firmware, etc.) executed by computer processor hardware 413. Event management application 140-1 can configured to include instructions to implement any of the operations as discussed herein.

During operation of one embodiment, computer processor hardware 413 accesses computer readable storage media 412 via the use of interconnect 411 in order to launch, run, execute, interpret or otherwise perform the instructions in event management application 140-1 stored on computer readable storage medium 412.

Execution of the event management application 140-1 produces processing functionality such as event management process 140-2 in computer processor hardware 413. In other words, the event management process 140-2 associated with computer processor hardware 413 represents one or more aspects of executing event management application 140-1 within or upon the processor 413 in the computer system 450.

Those skilled in the art will understand that the computer system 450 can include other processes and/or software and hardware components, such as an operating system that controls allocation and use of hardware resources, software resources, etc., to execute event management application 140-1.

In accordance with different embodiments, note that computer system 450 may be any of various types of devices, including, but not limited to, a mobile computer, a personal computer system, a wireless device, base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, or in general any type of computing or electronic device.

It is noted that FIG. 4 illustrates an exemplary embodiment of the computer system 450, and that other embodiments of the computer system 450 may include more apparatus components, or fewer apparatus components, than the apparatus components illustrated in FIG. 4. Further, the apparatus components may be arranged differently than as illustrated in FIG. 4. For example, in some embodiments, the non-volatile memory resource 160 may be located at a remote site accessible to the computer system 450 via the Internet, or any other suitable network. In addition, functions performed by various apparatus components contained in other embodiments of the computer system 450 may be distributed among the respective components differently than as described herein.

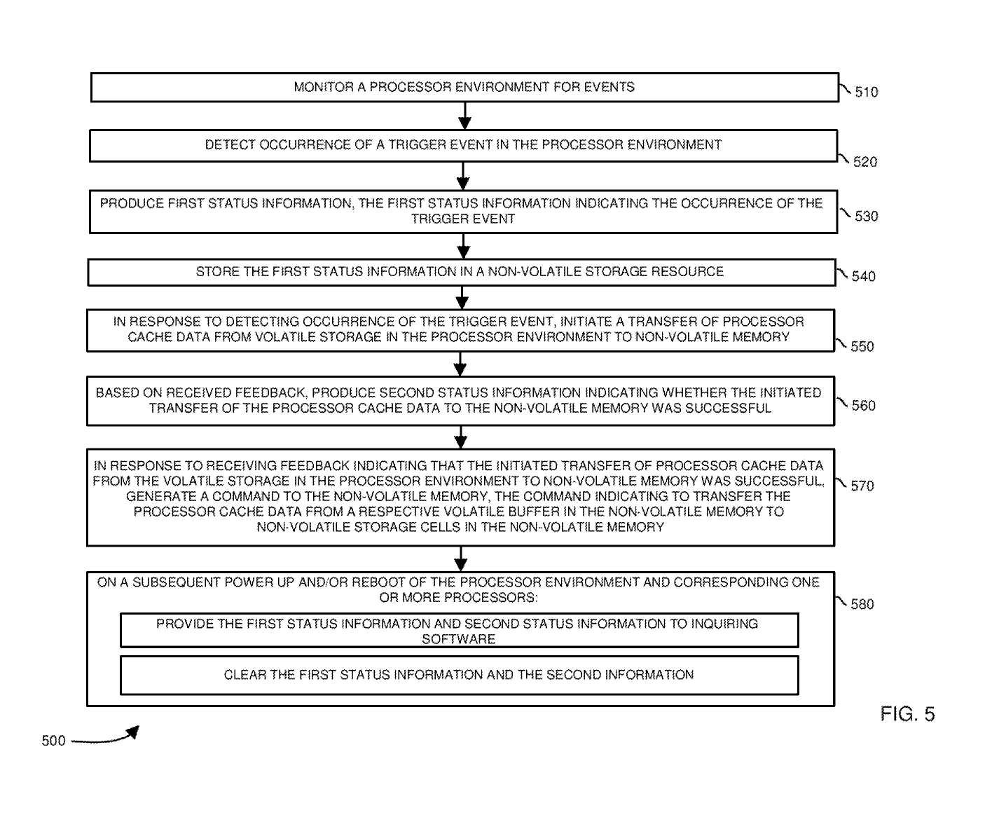

Functionality supported by the different resources will now be discussed via flowchart in FIG. 5. Note that the processing in the flowcharts below can be executed in any suitable order.

FIG. 5 is a flowchart 500 illustrating an example method according to embodiments. Note that there will be some overlap with respect to concepts as discussed above.

In processing block 510, the event management resource 140 monitors a processor environment 100 for events.

In processing block 520, the event management resource 140 detects occurrence of a trigger event in the processor environment 100.

In processing block 530, the event management resource 140 produces status information 188-1 indicating the occurrence of the trigger event.

In processing block 540, the event management resource 140 stores the status information 188-1 in storage resource 195. Storage resource 195 can be co-located or disparately located with respect to event management resource 140.

In processing block 550, in response to detecting occurrence of the trigger event, the event management resource 140 initiates a transfer of processor cache data from volatile storage (such as from caches 120) in the processor environment 100 to non-volatile memory resource 160.

In processing block 560, based on received feedback (such as signal 111-5), the event management resource 140 produces status information 188-2 indicating whether the initiated transfer (such as transfers 112, transfers 312, . . . ) of the processor cache data to the non-volatile memory resource 160 was successful.

In processing block 570, in response to receiving feedback (such as signal 111-5) indicating that the initiated transfer of processor cache data from the volatile storage (such as from caches 120) in the processor environment 100 to non-volatile memory resource 160 was successful, the event management resource 140 generates a command (such as signal 111-6) to the non-volatile memory resource 160. In one embodiment, the command indicates to transfer the processor cache data from a respective (volatile) buffer 165 (such as temporary storage) in the non-volatile memory resource 160 to non-volatile storage cells 167 in the non-volatile memory resource 160.

In processing block 580, on a subsequent power up and/or reboot of the processor environment and corresponding one or more processors, the event management resource 140 provides the status information 188-1 and status information 188-2 to inquiring software such as a fault manager, initialization resource 310, executed logic 320, etc. Additionally, in a manner as previously discussed, after providing the status information 188, the event management resource 140 (or other suitable resource) clears the status information 188-1 and the information 188-2.

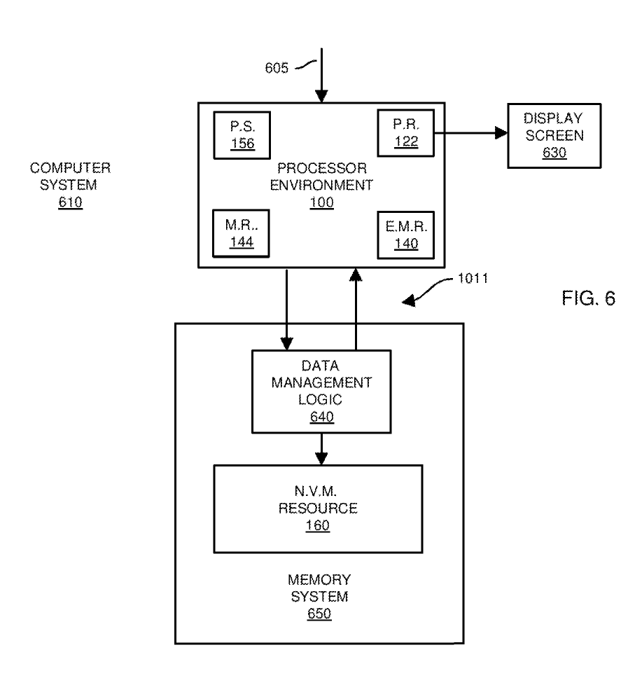

FIG. 6 is an example diagram illustrating use of a memory system in a respective computer system according to embodiments herein.

As shown, computer system 610 can include processor environment 100 (and corresponding resources such as power supply 156, processor resource 122, monitor resource 144, event management resource 140, etc.), display screen 630, and non-volatile memory resource 150.

As previously discussed, processor resource 122 can include computer processor hardware such as one or more processor units 110. By way of a non-limiting example, computer system 610 can be any suitable type of resource such as a personal computer, cellular phone, mobile device, camera, etc., using non-volatile memory resource 160 in memory system 650 to store data.

In one embodiment, memory system 650 includes non-volatile memory resource 160. Memory system 650 can be a solid-state drive used to store data.

Processor resource 122 has access to memory system 650 and corresponding non-volatile memory resource 150 via interface 1011.

Interface 1011 can be any suitable link enabling data transfers. For example, the interface 1011 can be a SCSI (Small Computer System Interface), SAS (Serial Attached SCSI), SATA (Serial Advanced Technology Attachment), USB (Universal Serial Bus), Pcie (Peripheral Component Interconnect Express) bus, etc.

Via interface 1011, any of the processor units 110 in the processor resource 122 of computer system 610 is able to retrieve data from and store data to memory system 650.

As an example, assume that the computer system 610 receives a request to perform a respective function as specified by input 605 from a user. The processor resource 122 executes a corresponding function as specified by the input 605. Execution of the corresponding function as specified by the input 605 can include transmitting a request over interface 1011 to data management logic 640 for retrieval of data at a specified logical address associated with the input 605.

In addition to performing other possible functions the data management logic 640 can be configured to map the logical address associated with input 605 to an appropriate physical address in memory system 650 and retrieve the corresponding data at the physical address from non-volatile memory resource 640. Subsequent to retrieving the appropriate data from memory system 650, data management logic 640 transmits the retrieved data to processor resource 122 satisfying the request for data. Accordingly, the processor resource 122 can be configured to retrieve data from memory system 650.

In one non-limiting example embodiment, the processor resource 122 initiates display of an image on display screen 630 depending on the data received from the data management logic 640.

As a further example, note that the processor resource 122 can receive a request to perform a respective function as specified by input 605 from a user. In one embodiment, in response to receiving the request to execute the function, processor source 122 executes the function and communicates with data management logic 140 to store data at a logical address as specified by the processor resource 122. In response to receiving the request, the data management logic 140 maps the logical address to an appropriate physical address and stores the received data in a corresponding location of the non-volatile memory resource 160.

Accordingly, the processor resource 122 can be configured to retrieve data from and write data to corresponding member system 650.

Note again that during abnormal conditions (such as during a power failure, software reset, thermal condition, etc.), the event management resource 140 (or system management interrupt handler 340) in processor environment 100 can be configured to manage storage of cache data to non-volatile memory resource 150 in a manner as previously discussed. Status information 188 provides notification of such events and whether corresponding cache data was properly stored. Accordingly, on subsequent power or reboot, inquiring software can detect occurrence of a respective event as well as whether cache data was properly stored prior to complete consumption of temporary hold-up power provided by energy storage resource 102.

If desired, the processor resource 122 (or other suitable resource) can be configured to retrieve cache data (and other related data such as queue data) stored to non-volatile memory resource 160 and restore the caches 120 back to their corresponding state prior to the event causing the shut down of processor resource 122.

Note that no element, operation, or instruction employed herein should be construed as critical or essential to the application unless explicitly described as such. Also, as employed herein, the article “a” is intended to include one or more items. Where only one item is intended, the term “one” or similar language is employed. Further, the phrase “based on” is intended to mean “based at least in part, on” unless explicitly stated otherwise.

While details have been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the embodiments herein are presented in the following claims.

1-25. (canceled)

26. A method comprising:
monitoring a processor environment; and
in response to detecting occurrence of a trigger event in the processor environment, initiating a transfer of processor cache data from volatile storage in the processor environment to non-volatile memory.

27. The method as in claim 26 further comprising:
producing status information associated with the transfer; and
storing the status information for later retrieval.

28. The method as in claim 26 further comprising:
producing status information to indicate whether the initiated transfer of the processor cache data to the non-volatile memory was successful; and
storing the status information in a non-volatile storage resource.

29. The method as in claim 28, wherein the status information is first status information, the method further comprising:
producing second status information, the second status information indicating the occurrence of the trigger event; and
storing the second status information in a non-volatile storage resource.

30. The method as in claim 29 further comprising:
on a subsequent power up of the processor environment, providing access to the first status information and second status information.

31. The method as in claim 29 further comprising:
on a reboot of multiple processors in the processor environment, initiating storage of the first status information and the second status information in a fault log.

32. The method as in claim 29 further comprising:
on a subsequent reboot of multiple processors in the processor environment after detecting the occurrence of the trigger event, resetting the first status information and the second information on a respective software reboot of the multiple processors.

33. The method as in claim 26, wherein the processor environment includes multiple processor units and multiple corresponding caches; and
wherein initiating the transfer of processor cache data to non-volatile memory includes initiating a transfer of processor cache data in each of the multiple corresponding caches to the non-volatile memory.

34. The method as in claim 33 further comprising:
selecting a particular processor unit amongst the multiple processor units, the particular processor unit executing a transfer of processor cache data in each of the multiple corresponding caches to the non-volatile memory.

35. The method as in claim 26 further comprising:
initiating execution of an SMI (System Management Interrupt) handler, the SMI handler executing operations of:
monitoring the processor environment;
detecting the trigger event in the processor environment, the trigger event received as an interrupt, the interrupt causing the SMI handler to initiate the transfer of the processor cache data from volatile storage in the processor environment to the non-volatile memory.

36. The method as in claim 26, wherein detecting the trigger event includes:
i) detecting occurrence of a power failure condition indicating that primary power supplied to the processor environment has been interrupted,
ii) detecting occurrence of a software initiated reset condition, or
iii) detecting occurrence of a thermal condition in the processor environment.

37. The method as in claim 26 further comprising:
in response to receiving feedback indicating that the initiated transfer of processor cache data from the volatile storage in the processor environment to non-volatile memory was successful, generating a command to the non-volatile memory, the command indicating to transfer the processor cache data from a respective volatile buffer in the non-volatile memory to non-volatile storage cells in the non-volatile memory.

38. An apparatus comprising:
a monitor resource, the monitor resource monitoring a processor environment for trigger events; and
a management resource communicatively coupled to the monitor resource, the management resource initiating a transfer of processor cache data from volatile storage in the processor environment to non-volatile memory in response to detecting occurrence of a trigger event in the processor environment.

39. The apparatus as in claim 38 further comprising:
a non-volatile storage resource; and
wherein the management resource is configured to produce status information indicating whether the initiated transfer of the processor cache data to the non-volatile memory was successful, the management resource storing the status information in the non-volatile storage resource.

40. The apparatus as in claim 39, wherein the status information is first status information;
wherein the management resource produces second status information, the second status information indicating the occurrence of the trigger event; and
wherein the management resource stores the second status information in the non-volatile storage resource.

41. The apparatus as in claim 40, wherein the management resource resets the first status information and the second information on a subsequent reboot of multiple processors in the processor environment after detecting the occurrence of the trigger event.

42. The apparatus as in claim 38, wherein the processor environment includes multiple processors and multiple corresponding caches; and
wherein the management resource initiates a transfer of processor cache data in each of the multiple corresponding caches to the non-volatile memory.

43. The apparatus as in claim 42, wherein a particular processor executes a transfer of processor cache data in each of the multiple corresponding caches to the non-volatile memory.

44. The apparatus as in claim 38, wherein the management resource is an SMI handler, the SMI handler executing operations of:
receiving an interrupt, the interrupt causing the SMI handler to initiate the transfer of the processor cache data from volatile storage in the processor environment to the non-volatile memory.

45. The apparatus as in claim 38 further comprising:
wherein the management resource receives feedback indicating that the initiated transfer of processor cache data from the volatile storage in the processor environment to non-volatile memory was successful; and
wherein the management resource, in response to the transfer being successful, generates a command to the non-volatile memory, the command indicating to transfer the processor cache data from a respective volatile buffer in the non-volatile memory to non-volatile storage cells in the non-volatile memory.

46. A computer system including the apparatus in claim 38, wherein the processor environment includes multiple processors, each of which produces a portion of the processor cache data.

47. The computer system as in claim 46 further comprising:
a display screen on which to render an image based at least in part on a portion of the processor cache data.

48. Computer-readable storage hardware having instructions stored thereon, the instructions, when carried out by computer processor hardware, cause the computer processor hardware to perform operations of:
monitoring a processor environment; and
in response to detecting occurrence of a trigger event in the processor environment, initiating a transfer of processor cache data from volatile storage in the processor environment to non-volatile memory.

49. The computer-readable storage hardware as in claim 48, wherein the instructions further cause the computer processor hardware to perform operations of:
producing first status information indicating the occurrence of the trigger event; and
storing the first status information in a non-volatile storage resource.

50. The computer-readable storage hardware as in claim 49, wherein the instructions further cause the computer processor hardware to perform operations of:
producing second status information to indicate whether the initiated transfer of the processor cache data to the non-volatile memory was successful; and
storing the second status information in the non-volatile storage resource.

51. The computer-readable storage hardware as in claim 50, wherein the instructions further cause the computer processor hardware to perform operations of:
on a subsequent reboot of multiple processors in the processor environment after detecting the occurrence of the trigger event, resetting the first status information and the second information.
